(19) United States
(12) Patent Application Publication
(10) Pub. No.: US 2008/0218632 A1
(43) Pub. Date: Sep. 11, 2008

(54) METHOD AND APPARATUS FOR MODIFYING TEXT-BASED SUBTITLES

(75) Inventors: Kil-soo JUNG, Hwasaong-si (KR); Sung-wook Park, Saoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/964,089

(22) Filed: Dec. 26, 2007

(30) Foreign Application Priority Data
Mar. 7, 2007 (KR) 2007-22586

(51) Int. Cl. H04N 7/00

(52) U.S. Cl. 348/468; 348/E07.001

(57) ABSTRACT

A method of modifying text-based subtitles reproduced with an audio visual (AV) data, a method of decoding text subtitles, a text subtitle decoder for modifying text-based subtitles, and a reproduction apparatus. The method of modifying text subtitles includes receiving source and target words; searching first text subtitle data for the source word and generating second text subtitle data by changing instances of the source word in the first text subtitle data to the target word; generating connection information between the first and second text subtitle data; and upon a reproduction request, selecting the first text subtitle data or the second text subtitle data with reference to the connection information and reproducing the first text subtitle data or the second text subtitle data with the AV data. According to aspects of the present invention, a user may easily modify text subtitles without performing a complicated editing process.

### CROSS-REFERENCE TO RELATED APPLICATIONS

This application claims the benefit of Korean Patent Application No. 2007-22586, filed in the Korean Intellectual Property Office on Mar. 7, 2007, the disclosure of which is incorporated herein by reference.

### BACKGROUND OF THE INVENTION

1. Field of the Invention

Aspects of the present invention relate to a method of modifying text-based subtitles that are reproduced using audio visual (AV) data, a method of decoding text subtitles, a text subtitle decoder for modifying text-based subtitles, and an apparatus for reproducing AV data and text-based subtitles.

2. Description of the Related Art

Conventionally, subtitle data in a bitmap image format has been used to provide subtitles when AV data is reproduced. Currently, subtitle data in a text format or subtitle data in both bitmap image and text formats are being developed and used. If subtitle data in the bitmap image format is used, a user cannot modify the subtitle data as desired. Although the subtitle data in the text format is used, it is still difficult for the user to edit a subtitle file.

### SUMMARY OF THE INVENTION

Aspects of the present invention provide a method of easily and conveniently modifying text-based subtitles even when audio visual (AV) data is being reproduced, a method of decoding text subtitles, a text subtitle decoder for modifying text-based subtitles, and an apparatus for reproducing AV data and modifying text-based subtitles.

According to an aspect of the present invention, a method of modifying text subtitles is provided. The method includes receiving source and target words; searching first text subtitle data for the source word and generating second text subtitle data by changing instances of the source word in the first text subtitle data to a target word; generating connection information between the first and second text subtitle data;, selecting the first text subtitle data or the second text subtitle data with reference to the connection information upon a reproduction request; and reproducing the first text subtitle data or the second text subtitle data with audio visual (AV) data in response to the reproduction request.

According to another aspect of the present invention, the method further includes recording the second text subtitle data and the connection information into a separate storage medium that is different from the storage medium in which the first text subtitle data is recorded.

According to another aspect of the present invention, the generating of the second text subtitle data includes modifying the first text subtitle data by changing the source word to the target word for a predetermined section displayed on a screen or for the entire first text subtitle data, in accordance with a type of modification request.

According to another aspect of the present invention, the connection information includes identification information of the first text subtitle data and location information of the second text subtitle data.

According to another aspect of the present invention, the receiving of the source and target words and the generating of the second text subtitle data may be performed in accordance with an execution request for a predetermined menu during the reproducing of the AV data, and the reproducing of the first text subtitle data or the second text subtitle data with the AV data may include reproducing the AV data with the second text subtitle data instead of the first text subtitle data from a point in time when the reproducing is requested.

According to another aspect of the present invention, if the reproducing is completed and the AV data is subsequently reproduced again, the reproducing of the first text subtitle data or the second text subtitle data with the AV data may include reproducing the AV data with the second text subtitle data if the connection information exists, and reproducing the AV data with the first text subtitle data if the connection information does not exist.

According to another aspect of the present invention, if the reproducing is completed and the AV data is subsequently reproduced again, the reproducing of the first text subtitle data or the second text subtitle data with the AV data may include reproducing the AV data with the first text subtitle data.

According to another aspect of the present invention, a method of decoding text subtitles is provided. The method includes generating second text subtitle data by modifying at least a part of first text subtitle data, generating connection information between the first and second text subtitle data, and recording the second text subtitle data and the connection information in a second storage medium if modification of the text subtitles is requested; selecting and parsing the first text subtitle data or the second text subtitle data with reference to the connection information if text subtitles are required; and generating a subtitle image using the parsing result.

According to another aspect of the present invention, the method further includes searching the first text subtitle data for an input source word and obtaining location information of the source word, and the generating of the second text subtitle data includes generating the second text subtitle by changing at least one source word included in the first text subtitle data to a target word with reference to the location information.

According to another aspect of the present invention, if the connection information exists in the second storage medium, the parsing includes parsing the second text subtitle data instead of the first text subtitle data with reference to location information of the second text subtitle data included in the connection information.

According to another aspect of the present invention, if a request to switch to the second text subtitle data is received during the parsing of the first text subtitle data, the parsing may include parsing the second text subtitle data instead of the first text subtitle data from a point in time when the request is received.

According to another aspect of the present invention, a text subtitle decoder is provided. The text subtitle decoder includes a declarative engine to generate second text subtitle data by modifying at least a part of first text subtitle data, to generate connection information between the first and second text subtitle data, to record the second text subtitle data and the connection information into a second storage medium, and to select and parse the first text subtitle data or the second text subtitle data with reference to the connection information if text-based subtitles are required; and a layout manager to generate a subtitle image using the parsing result input from the declarative engine.

According to another aspect of the present invention, the text subtitle decoder further includes a search engine to search the first text subtitle data for a source word input from the declarative engine, and the declarative engine generates the second text subtitle by changing at least one source word included in the first text subtitle data to a target word with reference to location information of the source word input from the search engine.

According to another aspect of the present invention, an apparatus to reproduce audio visual (AV) data and text-based subtitles is provided. The apparatus includes a first storage medium in which the AV data and first text subtitle data are recorded; a second storage medium; a presentation engine to generate second text subtitle data by modifying at least a part of the first text subtitle data, to generate connection information between the first and second text subtitle data, to record the second text subtitle data and the connection information in the second storage medium, to select and decode the first text subtitle data or the second text subtitle data with reference to the connection information, and to reproduce the first text subtitle data or the second text subtitle data with the AV data; and a navigation manager to control reproduction of the AV data and the first text subtitle data or the second text subtitle data.

According to another aspect of the present invention, the presentation engine includes a video decoder and an audio decoder to reproduce the AV data, and a text subtitle decoder including a declarative engine to generates the second text subtitle data and the connection information and to parse the first text subtitle data or the second text subtitle data with reference to the connection information if text-based subtitles are required, and a layout manager to generate a subtitle image using the parsing result input from the declarative engine.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a structure of a reproduction apparatus, according to an embodiment of the present invention;

FIG. 2 is a flowchart illustrating a method of modifying text subtitles, according to an embodiment of the present invention;

FIG. 3 is a diagram illustrating a user interface of an application for modifying text subtitles, according to an embodiment of the present invention; and

FIG. 4 is a diagram illustrating a user interface of an application for modifying text subtitles, according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

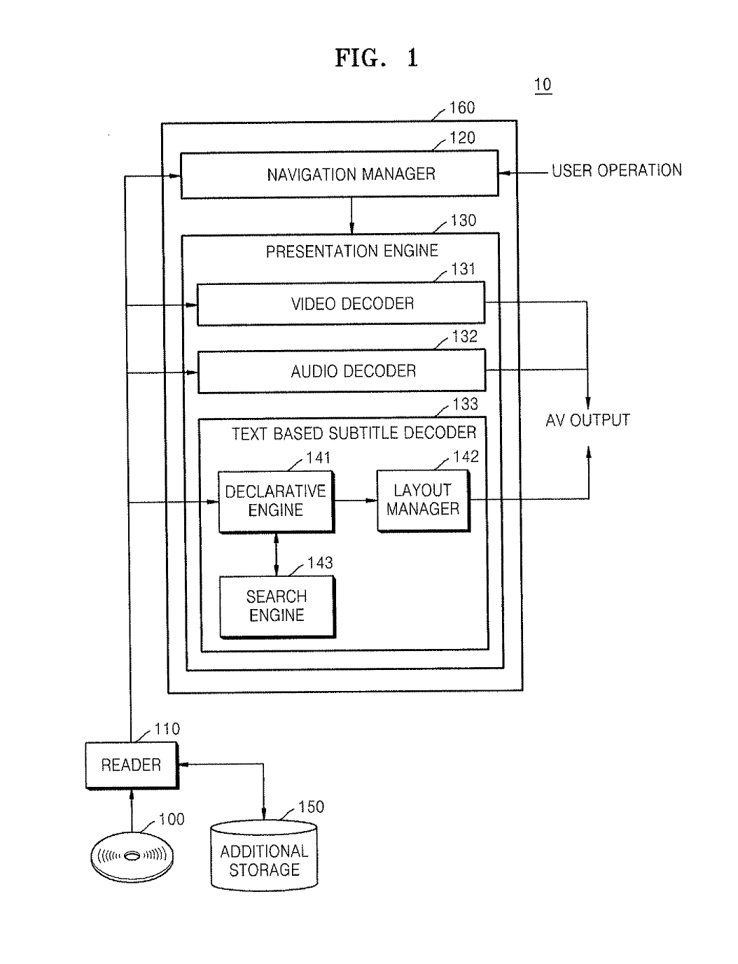

FIG. 1 is a diagram illustrating a structure of a reproduction apparatus 10, according to an embodiment of the present invention. The reproduction apparatus 10 includes a first storage medium 100 such as a disk in which AV data and text-based subtitles provided by a manufacturer of the AV data are recorded, a second storage medium 150 storing text subtitle data modified by a user so as to modify text subtitles and connection information in between the two text subtitle data, and a reading unit 110 that reads data from the first and second storage media 100 and 150. A hard disk (HDD) or a flash memory may be used as the second storage medium 150. However, the present invention is not limited thereto. The first and/or second storage media 100, 150 may be part of the reproduction apparatus 10 or may be provided separately, such as via a wired or wireless connection or over the Internet.

The reproduction apparatus also includes a reproduction unit 160 that reproduces the AV data and the text subtitles. The reproduction unit 160 includes a navigation manager 120 and a presentation engine 130. The navigation manager 120 controls reproduction of the AV data and the text subtitle data of the presentation engine 130 with reference to navigation data and the user's input. The navigation data defines how the reproduction apparatus reproduces the AV data. The presentation engine 130 decodes and reproduces presentation data under the control of the navigation manager 120, and selectively reproduces the text subtitle data that is to be reproduced with reference to the connection information. The presentation data is reproduction data that is to be used to reproduce video streams, audio streams, and the text subtitle data. The presentation data may also include other data to be reproduced. The reproduction apparatus 10 according to other aspects of the invention may include additional or different components; similarly, one or more of the above-described components may be included in a single unit. The reproduction apparatus may be a desktop computer, a home entertainment device, a portable computer, a personal digital assistant, a personal entertainment device, a digital camera, a mobile phone, etc.

The presentation engine 130 includes a video decoder 131 that decodes the video streams in accordance with the control of the navigation manager 120, an audio decoder 132 that decodes the audio streams in accordance with the control of the navigation manager 120, and a text subtitle decoder 133 that decodes the text subtitle data. The text subtitle decoder 133 includes a declarative engine 141 that parses subtitle data streams and forms a document structure, a search engine 143 that searches the text subtitle data for a certain word or phrase requested by the user, and a layout manager 142 that generates a subtitle image using the results of the parsing. The results of the parsing may include text information and/or font information. The results of the parsing are transmitted from the declarative engine 141 so as to output the subtitles to a screen. The screen may be part of the reproducing apparatus 10 or may be connected to the reproducing apparatus 10.

The declarative engine 141 generates second text subtitle data by modifying at least a part of first text subtitle data recorded in the first storage medium 100, generates connection information between the first and second subtitle data, and records the second text subtitle data and the connection information in the second storage medium 150. According to other aspects of the invention, the declarative engine 141 may generate the text subtitle data at least in part by adding or deleting text to/from the first text subtitle data. The text information may be recorded in any format, such as plain text, as a markup document, or as a portion of a markup document.

If the text subtitles are required when the reproduction of the AV data is started or the AV data is being reproduced, the declarative engine 141 selects and parses the first text subtitle data or the second text subtitle data with reference to the connection information and outputs the result thereof to the layout manager 142. The connection information may include identification information of the first text subtitle data and uniform resource identifier (URI) information. The identification information identifies from which text subtitle data the second text subtitle data was modified. The URI information includes information on a location and a path of the second text subtitle data.

There may be various conditions under which the second text subtitle data is reproduced instead of the first text subtitle data. For example, if the modified text subtitle data is generated before the AV data is reproduced and the connection information is recorded in the second storage medium 150 when the AV data starts to be reproduced, the declarative engine 141 outputs the modified subtitles by reading and parsing the second text subtitle data. In another example, if the first text subtitle data is modified by the user while the AV data is being reproduced with the first text subtitle data and the AV data is requested to be reproduced continuously, the second text subtitle data may be parsed and output instead of the first text subtitle data.

In another example, if the user has modified a certain scene of the AV data or a certain part of the text subtitle data as desired and the AV data is subsequently reproduced continuously, the original first text subtitle data may be reproduced again after the certain modified scene or the certain modified part is reproduced. In another example, if the second text subtitle data is generated by the user's request and subtitle switching is subsequently requested during reproduction of the AV data, the first text subtitle data may be switched to or from the second text subtitle data with reference to a point in time when the subtitle switching is requested. The above-described examples are not limiting; other aspects of the present invention may reproduce the second text subtitle data under any condition.

The declarative engine 141 supports an application that modifies a part of the text subtitle data with a word or phrase as desired by the user. The user may input or select a source word/phrase and a target word/phrase to be output instead of just the source word/phrase using the application. The user may also select a range of the text subtitle data to be modified by the application. The user may select whether to change the source word/phrase for the entire text subtitle data, for a predetermined section of the text subtitle data, for a predetermined scene, or for a predetermined part of the subtitles. The text subtitle modification application is executed in accordance with an execution request for a predetermined menu. For example, the application may be executed by selecting a ‘Set’ menu or may be executed after pausing the AV data being reproduced when an input signal by a predetermined key, such as a subtitle modification key, is input from a user input device while the AV data is being reproduced.

The search engine 143 searches the first text subtitle data for the source word/phrase input from the declarative engine 141, obtains information on at least one location where the source word/phrase exists, and transfers the information to the declarative engine 141. The declarative engine 141 generates the second text subtitle data by changing at least one source word/phrase included in the first text subtitle data to the target word/phrase with reference to the location information of the source word/phrase input from the search engine 143, and then records the second text subtitle data in the second storage medium 150. The declarative engine 141 also records the connection information (which includes identification information of the first text subtitle data and location information of the second text subtitle data) in the second storage medium 150 in order to refer to the connection information when the subtitles are reproduced again later. However, the second text subtitle data and the connection information may be recorded in different storage media according to other aspects of the present invention. For example, the second text subtitle information could be stored on a remote computer accessible via the Internet or a home network and the connection information could be stored on a storage medium included within the recording apparatus 10.

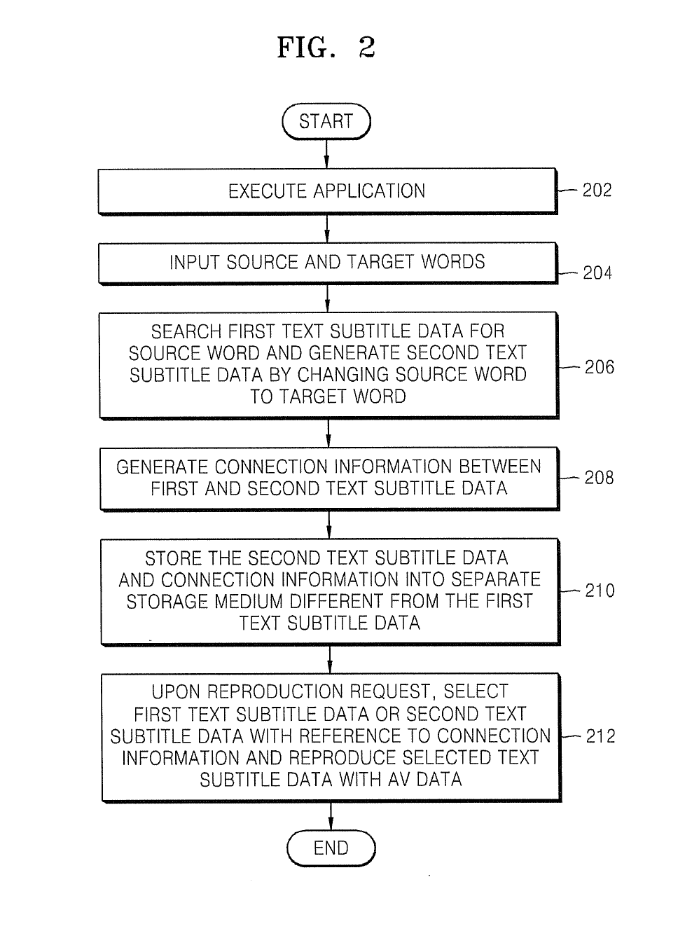

FIG. 2 is a flowchart illustrating a technique of modifying text subtitles according to an embodiment of the present invention. The flowchart illustrated in FIG. 2 will be described in conjunction with FIG. 1. An application for modifying text subtitles is executed in operation 202. When the application is executed, the declarative engine 141 parses the first text subtitle data that is to be modified.

The declarative engine 141 receives source and target word/phrases from the user in operation 204. The source and target word/phrases are input to the declarative engine 141 through the navigation manager 120. When the declarative engine 141 transfers the source word/phrase to the search engine 143, the search engine 143 searches the first text subtitle data for the source word/phrase and transfers the search result to the declarative engine 141. As used herein, the term ‘word’ also refers to phrases and/or sentences. Thus, the source word and/or the target word may be a phrase or a sentence.

The declarative engine 141 generates second text subtitle data by changing the source word of the first text subtitle data to the target word in operation 206. Generally, since text subtitle data includes text data and information on subtitle reproduction time (such as a starting time, an ending time, and a displaying time,) the declarative engine 141 may easily generate new text subtitle data by simply modifying a part of the text data while maintaining the information on the subtitle reproduction time of the first text subtitle data.

In addition to generating the second text subtitle data by modifying the first text subtitle data, the declarative engine 141 may also generate the second text subtitle data by adding or deleting a word/phrase from the first text subtitle data. In the case of adding a word, the source word may be a word/phrase to which text is to be added, and the target word may be the source word plus the text to be added. In the case of deleting a word/phrase, the source word may be a phrase from which text is to be deleted, and the target word may be the phrase without the text to be deleted.

The declarative engine 141 generates connection information between the first and second text subtitle data in operation 208. In operation 210, the connection information is stored in the second storage medium 150, not in the first storage medium 100 (where the first text subtitle data is stored.) Upon a reproduction request, the declarative engine 141 selects the first text subtitle data or the second subtitle data with reference to the connection information and reproduces AV data with the selected text subtitle data in operation 212.

For example, if subtitle switching is requested by the user during reproduction of a video file including the first text subtitle data, the declarative engine 141 checks the connection information stored in the second storage medium 150 in order to determine whether the first text subtitle data that is currently being reproduced or selected has been modified before by the user. If the connection information with the first text subtitle data of the currently selected first storage medium 100 does not exist, the user may be notified that the second text subtitle data that is to be switched to does not exist, or the first text subtitle data may be reproduced. If the connection information exists, the second text subtitle data reproduced instead of the first text subtitle data.

According to an embodiment of the present invention, when reproduction of the AV data of the first storage medium 100 is completed and is subsequently reproduced again, the AV data may be reproduced with the first text subtitle data. In this case, subtitle switching is performed at certain times as the user desires.

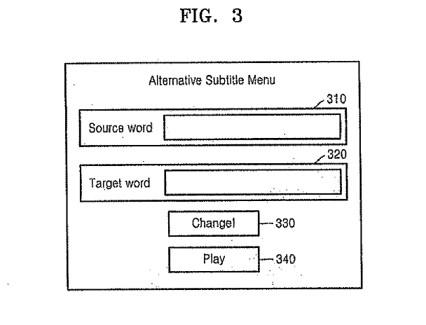

FIG. 3 is a diagram illustrating a user interface of an application for modifying text subtitles, according to an embodiment of the present invention. A ‘Source Word’ input box 310, in which text that is to be changed from original text subtitle data is input, and a ‘Target Word’ input box 320, in which text that is to be changed to new text subtitle data is input, are provided to the user. When a ‘Change!’ button 330 is selected, the new text subtitle data is generated by changing every source word of the original text subtitle data to a target word. For convenience of explanation, the term ‘word’ is used. However, the user may also change phrases or entire sentences. For example, the user may change a word into a phrase/sentence, a phrase/sentence into a word, or a phrase/sentence into another phrase/sentence. Similarly, the user may also add or delete words, phrases, or sentences. An ‘Add’ or a ‘Delete’ button may be provided for this purpose.

A ‘Play’ button 340 may be used to resume reproduction of a video file if the application is executed during the reproduction of the video file or may be alternatively used as a button that moves a current menu to an upper menu if the application is executed by selecting the Set menu of the reproduction apparatus 10. The terms used to describe the various buttons and input boxes 310-340 are exemplary and may be referred to using any terms. Additional buttons may also be provided according to other aspects of the invention, such as a ‘Save’ button to allow the user to store the generated second text subtitle data to the second storage medium 150.

Text may be input to the reproduction apparatus using a key board or a virtual keyboard displayed as an on-screen display (OSD). However, the present invention is not limited thereto. The text may also be input using a mouse, touchpad, clickwheel, microphone, or other device capable of receiving input from the user.

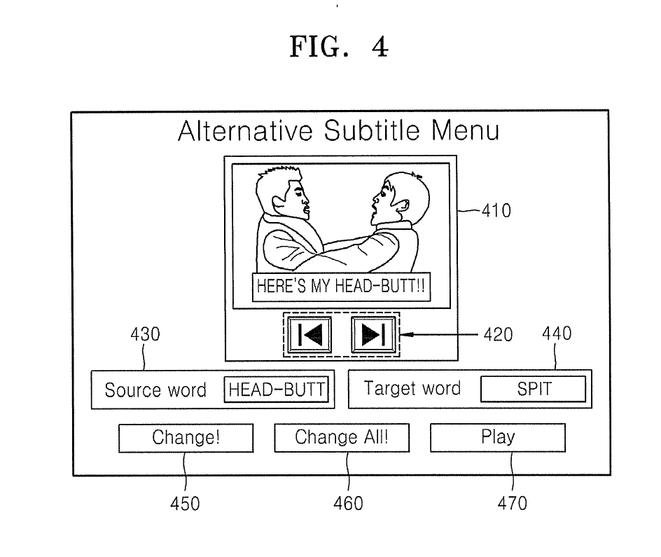

FIG. 4 is a diagram illustrating a user interface of an application for modifying text subtitles, according to another embodiment of the present invention. A video frame 410 displayed with original text subtitle data that is to be modified is provided. As shown in FIG. 4, the video frame 410 may be paused when a predetermined text subtitle phrase “Here's my head-butt!!” starts to be displayed, or the video frame 410 may be repeated from a starting time to an ending time of a period of time the corresponding text subtitle phrase “Here's my head-butt!!” is displayed. However, the present invention is not limited thereto. The video frame 410 may also be displayed in a different way with a method that attracts a user's attention, or with a method that is more convenient to use.

The above-described method of displaying the video frame 410 allows the user to be sufficiently aware of the text subtitle data in a section to be modified before inputting a target word. Buttons 420 at a lower portion of the video frame 410 allows a display of the video frame 410 to switch from the starting time to the ending time or from the ending time to the starting time of the period of time the corresponding text subtitle phrase “Here's my head-butt!!” is displayed in accordance with information on reproduction time of the original text subtitle data. After the display of the video frame 410 is switched to the starting time, the video frame 410 may be paused or may be repeated from the starting time to the ending time.

The source word and the target word are input into input boxes 430 and 440 below the video frame 410, respectively. As shown in FIG. 4, the source word “head-butt” from the text subtitle phrase “Here's my head-butt!!” is changed to the target word “spit”. If modified text subtitle data is requested to be reproduced, the text subtitle data in which a text subtitle phrase “Here's my spit!!” will be displayed instead of the text subtitle phrase “Here's my head-butt!!” for a corresponding scene or for the entire video file, in accordance with the type of modification request. The type of modification request may vary in accordance with a button selected by the user. A ‘Change!’ button 450 changes the source word to the target word for the text subtitle data of a section displayed on the video frame 410. A ‘Change All!’ button 460 changes the source word to the target word for the entire text subtitle data. A ‘Play’ button 470 may resume reproduction of the video file if the application is executed during the reproduction of the video file, or may be alternatively used as a button that moves a current menu to an upper menu if the application is executed by selecting the ‘Set’ menu of the reproduction apparatus 10. According to other aspects of the present invention, ‘Play’ button 470 may also be used as a button that reproduces AV data with the modified text subtitle data.

Subtitle modification techniques according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CDs and DVDs; magneto-optical media such as optical disks; and hardware devices that are specially configured to store and perform program instructions, such as read-only memory (ROM), random access memory (RAM), flash memory, and the like; and a computer data signal embodied in a carrier wave comprising a compression source code segment and an encryption source code segment (such as data transmission through the Internet). The computer readable recording medium can also be distributed over network coupled computer systems so that the computer readable code is stored and executed in a distributed fashion. Examples of program instructions include both machine code, such as produced by a compiler, and files containing higher level code that may be executed by the computer using an interpreter The described hardware devices may be configured to act as one or more software modules in order to perform the operations of the above-described embodiments of the present invention.

As described above, according to aspects of the present invention, the user may easily modify text subtitles without performing a complicated editing process and thereby increasing the convenience and pleasure of use.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of modifying text subtitles, the method comprising:
receiving a source word and a target word;
searching first text subtitle data for the source word and generating second text subtitle data by changing instances of the source word in the first text subtitle data to the target word;
generating connection information between the first and second text subtitle data;
selecting the first text subtitle data or the second text subtitle data with reference to the connection information upon a reproduction request; and
reproducing the first text subtitle data or the second text subtitle data with audio visual (AV) data in response to the reproduction request.

2. The method of claim 1, further comprising:
recording the second text subtitle data and the connection information into a separate storage medium that is different from a storage medium in which the first text subtitle data is recorded.

3. The method of claim 1, wherein the generating of the second text subtitle data comprises modifying the first text subtitle data by changing the source word to the target word for a predetermined section displayed on a screen or for the entire first text subtitle data, in accordance with a type of modification request.

4. The method of claim 1, wherein the connection information comprises identification information of the first text subtitle data and location information of the second text subtitle data.

5. The method of claim 1, wherein:
the receiving of the source and target words and the generating of the second text subtitle data are performed in accordance with an execution request for a predetermined menu during the reproducing of the AV data; and
the reproducing of the first text subtitle data or the second text subtitle data with the AV data comprises reproducing the AV data with the second text subtitle data instead of the first text subtitle data from a point in time when the reproducing is requested.

6. The method of claim 1, wherein, if the reproducing is completed and the AV data is subsequently reproduced again, the reproducing of the first text subtitle data or the second text subtitle data with the AV data comprises:
reproducing the AV data with the second text subtitle data if the connection information exists; and
reproducing the AV data with the first text subtitle data if the connection information does not exist.

7. The method of claim 1, wherein, if the reproducing is completed and the AV data is subsequently reproduced again, the reproducing of the first text subtitle data or the second text subtitle data with the AV data comprises reproducing the AV data with the first text subtitle data.

8. A method of decoding text subtitles comprising:
if modification of the text subtitles is requested, generating second text subtitle data by modifying at least a part of first text subtitle data, generating connection information between the first and second text subtitle data, and recording the second text subtitle data and the connection information in a second storage medium;
selecting and parsing the first text subtitle data or the second text subtitle data with reference to the connection information if text subtitles are required; and
generating a subtitle image using the parsing result.

9. The method of claim 8, further comprising:
searching the first text subtitle data for an input source word and obtaining location information of the source word;
wherein the generating of the second text subtitle data comprises generating the second text subtitle by changing at least one source word in the first text subtitle data to a target word with reference to the location information.

10. The method of claim 8, wherein the connection information comprises identification information of the first text subtitle data and location information of the second text subtitle data.

11. The method of claim 8, wherein, if the connection information exists in the second storage medium, the parsing comprises parsing the second text subtitle data instead of the first text subtitle data with reference to location information of the second text subtitle data included in the connection information.

12. The method of claim 8, wherein, if a request to switch to the second text subtitle data is received during the parsing of the first text subtitle data, the parsing comprises parsing the second text subtitle data instead of the first text subtitle data from a point in time where the request is received.

13. A text subtitle decoder comprising:
a declarative engine to generate second text subtitle data by modifying at least a part of first text subtitle data, to generate connection information between the first and second text subtitle data, to record the second text subtitle data and the connection information onto a second storage medium, and to select and parse the first text subtitle data or the second text subtitle data with reference to the connection information if text-based subtitles are required; and
a layout manager to generate a subtitle image using the parsing result input from the declarative engine.

14. The text subtitle decoder of claim 13, further comprising:
a search engine to search the first text subtitle data for a source word input from the declarative engine,
wherein the declarative engine generates the second text subtitle by changing at least one source word included in the first text subtitle data to a target word with reference to location information of the source word input from the search engine.

15. The text subtitle decoder of claim 13, wherein the connection information comprises identification information of the first text subtitle data and location information of the second text subtitle data.

16. The text subtitle decoder of claim 13, wherein, if the connection information exists in the second storage medium, the declarative engine parses the second text subtitle data instead of the first text subtitle data with reference to location information of the second text subtitle data included in the connection information.

17. The text subtitle decoder of claim 13, wherein, if a request to switch to the second text subtitle data is received during the parsing of the first text subtitle data, the declarative engine parses the second text subtitle data instead of the first text subtitle data from a point in time when the request is received.

18. An apparatus to reproduce audio visual (AV) data and text-based subtitles, the apparatus comprising:
a first storage medium in which the AV data and first text subtitle data are recorded;
a second storage medium;
a presentation engine to generate second text subtitle data by modifying at least a part of the first text subtitle data, to generate connection information between the first and second text subtitle data, to record the second text subtitle data and the connection information in the second storage medium, to select and decode the first text subtitle data or the second text subtitle data with reference to the connection information, and to reproduce the first text subtitle data or the second text subtitle data with the AV data; and
a navigation manager to control reproduction of the AV data and the first text subtitle data or the second text subtitle data.

19. The apparatus of claim 18, wherein the presentation engine comprises:
a video decoder and an audio decoder to reproduce the AV data, and
a text subtitle decoder comprising a declarative engine to generate the second text subtitle data and the connection information and to parse the first text subtitle data or the second text subtitle data with reference to the connection information if text-based subtitles are required, and a layout manager to generate a subtitle image using the parsing result input from the declarative engine.

20. The apparatus of claim 19, wherein:
the text subtitle decoder further comprises a search engine to search the first text subtitle data for a source word input from the declarative engine, and
the declarative engine receives the source word and a target word from a user through the navigation manager and generates the second text subtitle by changing at least one source word in the first text subtitle data to the target word with reference to location information of the source word input from the search engine.

21. The apparatus of claim 18, wherein the connection information comprises identification information of the first text subtitle data and location information of the second text subtitle data.

22. The apparatus of claim 18, wherein, if the connection information exists in the second storage medium, the presentation engine reproduces the second text subtitle data instead of the first text subtitle data with reference to location information of the second text subtitle data included in the connection information.

23. The apparatus of claim 18, wherein, if a request to switch to the second text subtitle data is received during the reproducing of the first text subtitle data, the presentation engine reproduces the second text subtitle data instead of the first text subtitle data from a point in time where the subtitle switching is received.

24. A computer readable recording medium having recorded thereon a computer program to execute the method of claim 1.

25. A computer readable recording medium having recorded thereon a computer program to execute the method of claim 8.

26. A reproducing apparatus comprising:
a presentation engine to reproduce audio data, video data, and first text subtitle data received from a first storage medium and to generate second text subtitle data by modifying the first text subtitle data; and
a navigation manager to control the presentation engine based on data from the first storage medium, a second storage medium, and/or input from a user.

27. The reproducing apparatus of claim 26, wherein the presentation engine comprises:
an audio decoder to decode the audio data; and
a video decoder to decode the video data.

28. The reproducing apparatus of claim 26, wherein the presentation engine comprises a declarative engine to generate the second text subtitle data by modifying at least a portion of the first text subtitle data, to generate connection information relating the second text subtitle data to the first text subtitle data, and to record the connection information and the second text subtitle data to the second storage medium.

29. The reproducing apparatus of claim 26, further comprising the second storage medium.

30. The reproducing apparatus of claim 26, wherein the second storage medium is connected to the reproducing apparatus via a network.

31. The reproducing apparatus of claim 26, wherein the second storage medium is connected to the reproducing apparatus via a cable.

32. The reproducing apparatus of claim 28, wherein the declarative engine generates the second text subtitle data by adding at least one source word to the first text subtitle data.

33. The reproducing apparatus of claim 28, wherein the declarative engine generates the second text subtitle data by deleting at least one source word from the first text subtitle data.

34. The reproducing apparatus of claim 28, wherein the declarative engine generates the second text subtitle data by replacing at least one instance of a target word in the first text subtitle data with a source word.

35. The reproducing apparatus of claim 28, wherein one of the source word and the target word is a phrase or a sentence.
